(19) United States
(12) Patent Application Publication
(10) Pub. No.: US 2026/0357380 A1
(43) Pub. Date: Nov. 12, 2026

(54) METHOD FOR PREPARING SUBMICRON NB5SI3 PARTICLE-REINFORCED NB-BASED REFRACTORY HIGH-ENTROPY ALLOY BY LASER/ELECTRON BEAM IN-SITU REACTION

(71) Applicant: AECC BEIJING INSTITUTE OF AERONAUTICAL MATERIALS, Beijing (CN)

(72) Inventors: Huaping XIONG, Beijing (CN); Shuai HUANG, Beijing (CN); Wei LIU, Beijing (CN); Chao GAO, Beijing (CN)

(73) Assignee: AECC BEIJING INSTITUTE OF AERONAUTICAL MATERIALS, Beijing (CN)

(21) Appl. No.: 19/488,628

(22) PCT Filed: Dec. 2, 2024
(86) PCT No.: PCT/CN2024/136037

§ 371 Date: Nov. 27, 2025

(30) Foreign Application Priority Data
Dec. 6, 2023 (CN) 202311669663.8

(51) Int. Cl. C22C 1/05; C04B 35/58; C04B 41/00

(52) U.S. Cl. CPC C22C 1/05; C04B 35/58092; C04B 41/0054; C04B 2235/3891; C04B 2235/528; C04B 2235/668

(57) ABSTRACT

Provided is a method for preparing a submicron Nb5Si3 particle-reinforced Nb-based refractory high-entropy alloy by a laser/electron beam in-situ reaction. Quasi-spherical composite powder of elemental Nb—Si with an atomic ratio of 5:3 is used as a raw material A, and an NbSS matrix alloy in the traditional refractory two-phase alloy is designed into an Nb(X, Y, Z . . . ) refractory high-entropy alloy (wherein X, Y, Z . . . means elements such as Ti, Zr, Hf, Nb, Ta, Mo, and V), which is prepared into spherical powder B by means of a rotating electrode atomization method; and then the A+B mixed powder is used as a raw material for laser/electron beam additive manufacturing, so that a submicron Nb5Si3 particle-reinforced Nb(X, Y, Z . . . ) refractory high-entropy alloy is prepared, and thus the particle-reinforced refractory high-entropy alloy is prepared by means of an in-situ reaction in a laser or electron beam selective melting process.

This application claims the priority of Chinese Patent Application No. 202311669663.8, filed with the China National Intellectual Property Administration on Dec. 6, 2023, and titled with “METHOD FOR PREPARING SUBMICRON NB₅SI₃ PARTICLE-REINFORCED NB-BASED REFRACTORY HIGH-ENTROPY ALLOY BY LASER/ELECTRON BEAM IN SITU REACTION”, which is hereby incorporated by reference in its entirety.

### FIELD

The present disclosure relates to the technical field of ultra-high temperature composite materials and manufacturing thereof, and in particular to a method for producing a Nb-based refractory high-entropy alloy reinforced with submicron Nb₅Si₃ particles by a laser in situ reaction or an electron beam in situ reaction.

### BACKGROUND

Nb₅Si₃/Nbₛₛ refractory dual-phase alloys, composed of a Nb₅Si₃ high-temperature reinforcing phase and a Nb solid solution (Nbₛₛ) room-temperature toughening phase, are a newly developed generation of ultra-high temperature structural materials with a target service temperature of 1200 °C to 1300 °C, and can serve as candidate materials for high-pressure turbine blades of future aero-engines. Herein, the Nbₛₛ generally refers to a solid solution such as (Nb, Ti)ss, (Nb, Ti, Zr)ss, or (Nb, Ti, Mo)ss. For the preparation of Nb₅Si₃/Nbₛₛ refractory dual-phase alloys, traditional melting and casting processes inevitably lead to problems such as segregation, non-uniform microstructure, and coarse grains. In such alloys, the size of the Nb₅Si₃ high-temperature reinforcing phase often reaches tens of micrometers, which severely compromises the overall properties of the alloys, especially the room-temperature plasticity and toughness. As a result, existing cast Nb₅Si₃/Nbₛₛ refractory dual-phase alloys commonly exhibit a mismatch between strength and toughness at room and medium-to-low temperatures, wherein insufficient room-temperature plasticity and toughness is the most prominent issue. In addition, the high-temperature strength is also inadequate. These issues severely hinder the engineering applications of Nb₅Si3/Nbₛₛ refractory dual-phase alloys.

In this field, on one hand, a key challenge that urgently needs to be addressed is how to refine the size of the Nb₅Si₃ high-temperature reinforcing phase in Nb₅Si₃/Nbₛₛ refractory dual-phase alloys down to a micro or even submicron scale, so as to fundamentally improve the room-temperature plasticity and toughness of the alloys. On the other hand, further improving the strength and toughness and the high-temperature strength of the Nbₛₛ is also a key issue to be addressed.

### SUMMARY

An object of the present disclosure is to provide a method for producing a Nb-based refractory high-entropy alloy reinforced with submicron Nb₅Si₃ particles by a laser in situ reaction or an electron beam in situ reaction. The method of the present disclosure can reduce the brittleness of the refractory alloy reinforced with particles and simultaneously improve its strength.

The present disclosure provides for a method for producing an alloy by a laser in situ reaction or an electron beam in situ reaction, wherein the alloy is a Nb-based refractory high-entropy alloy reinforced with submicron Nb₅Si₃ particles and the method comprises:
using near-spherical Nb—Si composite powders and spherical Nb-based refractory high-entropy alloy powders as raw materials, performing the laser in situ reaction or electron beam in situ reaction by selective melting, and obtaining the Nb-based refractory high-entropy alloy reinforced with submicron Nb₅Si₃ particles;
the near-spherical Nb—Si composite powders are obtained by solid-state pressureless sintering of Nb powders with a particle size of 10 to 20 μm and Si powders with a particle size of 1 to 5 μm; and
the Nb-based refractory high-entropy alloy is an alloy of Nb and at least one high-melting-point element selected from the group consisting of Ti, Zr, Hf, Nb, V, Ta, and Mo.

Preferably, the Nb powders and the Si powders have a mass ratio of 4:3 to 6:3.

Preferably, the solid-state pressureless sintering is performed at a temperature of 600 °C to 1000 °C for 0.5 to 2 h.

Preferably, a plasma spheroidization is performed after the solid-state pressureless sintering; and the plasma spheroidization is performed with an electric current of 600 to 800 A, a primary gas flow rate of 110 to 130 SCFH, an auxiliary gas flow rate of 5 to 15 SCFH, a carrier gas flow rate of 10 to 15 SCFH, and a powder feed rate of 1.5 to 3 r/min.

Preferably, the spherical Nb-based refractory high-entropy alloy powders are prepared from a Nb-based alloy bar by melting and a rotating electrode process;
and the rotating electrode process is performed in an atomization chamber with an inert gas working pressure of 0.115 to 0.135 MPa, a rotation speed of 40000 to 50000 r/min, an electric current of 700 to 800 A, and a feed rate of 1.5 to 2 mm/s.

Preferably, each element in the spherical Nb-based refractory high-entropy alloy powders has an atom percent of 5% to 30%.

Preferably, the laser in situ reaction is performed by a powder-fed laser additive manufacturing or by laser selective melting;
the powder-fed laser additive manufacturing is performed with a laser power of 700 to 1000 W, a scanning speed of 600 mm/min, and a powder feed rate of 1000 r/min; and
the laser selective melting is performed with a power of 250 to 300 W, a scanning speed of 900 to 1300 mm/s, a scanning spacing of 0.11 mm, and a layer thickness of 50 μm.

Preferably, the electron beam selective melting is performed with a vacuum level of 2×10⁻³±0.5×10⁻⁴ mbar, a working voltage of 60 kV, an electron beam power of 5000 to 6000 W, a layer thickness of 50 μm, and a preheating temperature of 300 °C to 700 °C.

Preferably, the mass ratio of the near-spherical Nb—Si composite powders and the spherical Nb-based refractory high-entropy alloy powders is (25 to 30):(70 to 75).

Preferably, a homogenization heat treatment is performed after the in situ reaction to obtain a Nb-based refractory high-entropy alloy reinforced with submicron Nb₅Si₃ particles;
and the homogenization heat treatment is performed at a temperature of 1350 °C to 1450 °C for 10 to 40 h.

The present disclosure provides a method for producing a Nb-based refractory high-entropy alloy reinforced with submicron Nb₅Si₃ particles by a laser in situ reaction or an electron beam in situ reaction, comprising: using near-spherical Nb—Si composite powders and spherical Nb-based refractory high-entropy alloy powders as raw materials, performing the laser in situ reaction or electron beam in situ reaction by selective melting, and obtaining the Nb-based refractory high-entropy alloy reinforced with submicron Nb₅Si₃ particles; the near-spherical Nb—Si composite powders are obtained by solid-state pressureless sintering of Nb powders with a particle size of 10 to 20 μm and Si powders with a particle size of 1 to 5 μm; and the Nb-based refractory high-entropy alloy is an alloy of Nb and at least one high-melting-point element selected from the group consisting of Ti, Zr, Hf, Nb, V, Ta, and Mo.

The present disclosure proposes using raw Si powders with a particle size of only 1 to 5 μm and raw Nb powders with a particle size of 10 to 20 μm. Through experiments and research, it has been demonstrated that under these conditions, a Nb₅Si₃/Nb(X, Y, Z . . . ) refractory high-entropy alloy reinforced with submicron Nb₅Si₃ particles can be obtained. Compared to a refractory alloy of the same composition obtained by casting, the size of the Nb₅Si₃ particle reinforcing phase can be significantly reduced from a level of tens of micrometers down to the submicron scale. In this way, on one hand, the brittleness of the particle-reinforced refractory alloy is greatly reduced, and on the other hand, based on the Orowan strengthening principle, the strength of the particle-reinforced refractory alloy will also be significantly improved.

Furthermore, the present disclosure designs a Nb(X, Y, Z . . . ) refractory high-entropy alloy as an alloy matrix for the alloys of the present disclosure. A super solid solution is formed within this type of multi-component refractory high-entropy alloy. Due to various strengthening and toughening mechanisms such as solid solution strengthening, lattice distortion strengthening, and precipitation strengthening, the Nb(X, Y, Z . . . ) refractory high-entropy alloys exhibit better strength and toughness as well as stable high-temperature strength compared to traditional binary alloys like Nb—Ti or ternary alloys like Nb—Ti—Zr or Nb—Ti—Mo. The Nb(X, Y, Z . . . ) refractory high-entropy alloys, reinforced with submicron Nb₅Si₃ particles obtained by in situ reaction additive manufacturing, is not only free of defects such as cracks during the additive manufacturing process, but the material or component so obtained by additive manufacturing can also be used directly in an as-manufactured state.

### BRIEF DESCRIPTION OF DRAWINGS

To describe the technical solutions in the examples of the present disclosure or in the prior art more clearly, a brief introduction to the drawings required for describing the examples or the prior art is given below. It should be apparent that the drawings in the following description are only some examples of the present disclosure, and a person of ordinary skill in the art can also obtain other drawings from the provided drawings without creative efforts.

FIG. 1 is an SEM image of Si powders with a particle size of 1 to 5 μm in Example 1;

FIG. 2 is an SEM image of Nb powders with a particle size of 10 to 20 μm in Example 1;

FIG. 3 is an SEM image of the near-spherical Nb—Si elemental composite powders obtained after plasma spheroidization in Example 1;

FIG. 4 is an SEM image of the spherical powders of Nb(Ti, Zr, Hf, V, Mo) refractory high-entropy alloy obtained in Example 5; and

FIG. 5 shows a microstructure of the Nb₅Si₃/Nb(Ti, Zr, Hf, V, Mo) refractory high-entropy alloy reinforced with submicron Nb₅Si₃ particles obtained by a laser in situ reaction in Example 5.

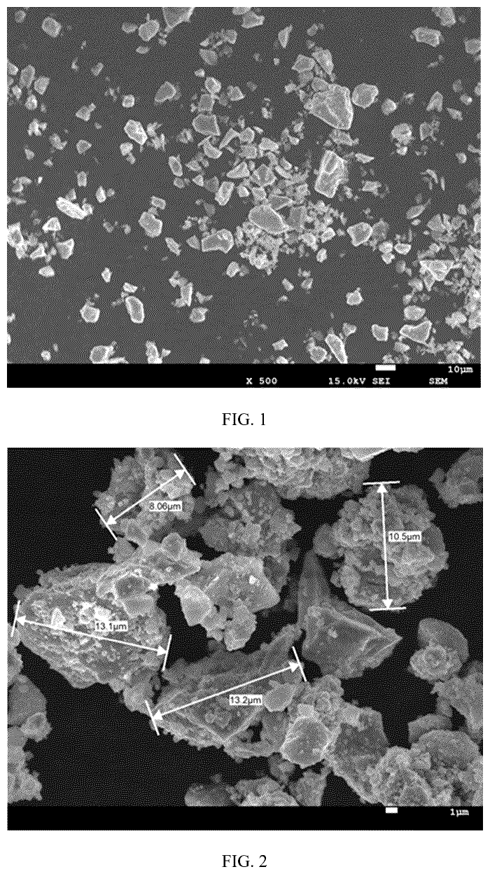

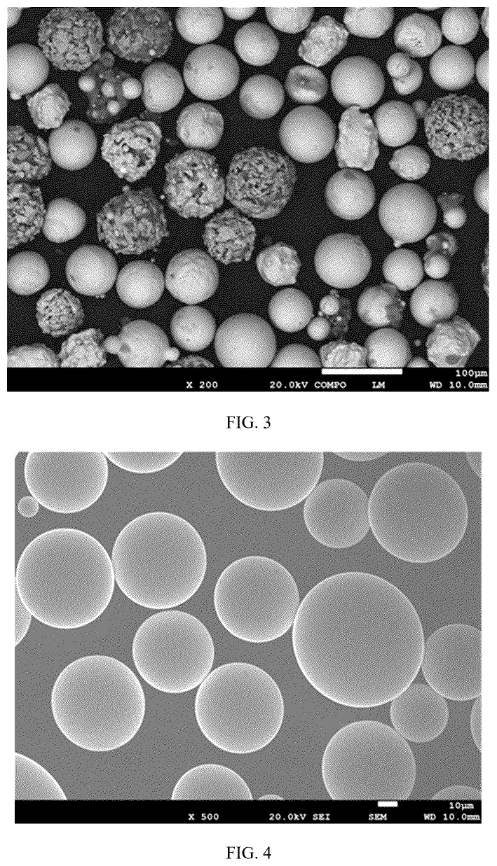

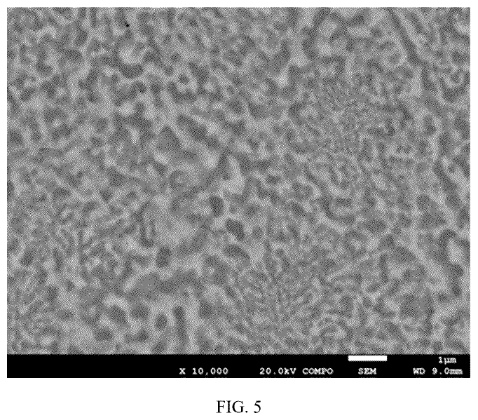

### DETAILED DESCRIPTION

The present disclosure provides a method for producing a Nb-based refractory high-entropy alloy reinforced with submicron Nb₅Si₃ particles by a laser in situ reaction or an electron beam in situ reaction, comprising:
using near-spherical Nb—Si composite powders and spherical Nb-based refractory high-entropy alloy powders as raw materials, performing the laser in situ reaction or electron beam in situ reaction by selective melting, and obtaining the Nb-based refractory high-entropy alloy reinforced with submicron Nb₅Si₃ particles;
the near-spherical Nb—Si composite powders are obtained by solid-state pressureless sintering of Nb powders with a particle size of 10 to 20 μm and Si powders with a particle size of 1 to 5 μm;
and the Nb-based refractory high-entropy alloy is an alloy of Nb and at least one high-melting-point element selected from the group consisting of Ti, Zr, Hf, Nb, V, Ta, and Mo.

In the present disclosure, near-spherical Nb—Si elemental composite powders are used as raw material A. Furthermore, the Nbₛₛ matrix alloy in the aforementioned traditional refractory dual-phase alloys is designed as a Nb(X, Y, Z . . . ) refractory high-entropy alloy (where X, Y, Z . . . refer to elements such as Ti, Zr, Hf, Nb, Ta, Mo, and V), which is prepared into spherical powders B by a rotating electrode process. Then, mixed powders of A and B are used as raw materials for laser/electron beam additive manufacturing to produce a Nb(X, Y, Z . . . ) refractory high-entropy alloy reinforced with submicron Nb₅Si₃ particles.

### Preparation of Near-Spherical Nb—Si Composite Powders

In the present disclosure, Si powders, Nb powders, PVA, and water are mixed and ball-milled to obtain a slurry, which is then subjected to a spray granulation process to obtain Nb—Si composite agglomerated powders with a controllable particle size range.

Using the Nb—Si composite agglomerated powders as raw materials, near-spherical Nb—Si composite powders are obtained by solid-state pressureless sintering.

In the present disclosure, the particle size of the Si powders is preferably 1 to 5 μm, and more preferably 2 to 4 μm, such as 1 μm, 2 μm, 3 μm, 4 μm, 5 μm, or in a range with any of the above values as an upper or lower limit. The particle size of the Nb powders is preferably 10 to 20 μm, and more preferably 12 to 18 μm, such as 10 μm, 11 μm, 12 μm, 13 μm, 14 μm, 15 μm, 16 μm, 17 μm, 18 μm, 19 μm, 20 μm, or in a range with any of the above values as an upper or lower limit.

In the present disclosure, the mass ratio of the Nb powders to the Si powders is (4 to 6):3, and preferably 5:3.

In the present disclosure, during the solid-state pressureless sintering process, the sintering is preferably performed under a protective argon atmosphere, wherein sintering densification and near-spheroidization are performed under conditions where neither of the two elements melts, and the Nb—Si composite particles still remain in an elemental state. The sintering is performed at a temperature of preferably 600 °C to 1000 °C, more preferably 700 °C to 900 °C, such as 600 °C, 700 °C, 800 °C, 900 °C, 1000 °C, or in a range with any of the above values as an upper or lower limit. The sintering is preferably performed for a duration of 0.5 to 2 h, and more preferably 1 to 1.5 h.

Preferably, in the present disclosure, after the solid-state pressureless sintering, the near-spherical Nb—Si composite powders are further subjected to a plasma spheroidization process.

In the present disclosure, during the preparation of the near-spherical Nb—Si composite powders by the plasma spheroidization, the plasma spheroidization under a protective argon atmosphere causes the surface layer of the Nb—Si composite agglomerated powders to melt while the interior remains in the elemental state of Nb and Si, achieving shaping and spheroidization of the powders. The plasma spheroidization is performed with an electric current of preferably 600 to 800 A, and more preferably 700 to 750 A; a primary gas flow rate of preferably 110 to 130 SCFH, and more preferably 115 to 125 SCFH; an auxiliary gas flow rate of preferably 5 to 15 SCFH, and more preferably 10 to 12 SCFH; a carrier gas flow rate of preferably 10 to 15 SCFH, and more preferably 12 to 13 SCFH; and a powder feed rate of preferably 1.5 to 3 r/min, and more preferably 2 to 2.5 r/min.

In principle, an in situ reaction occurs between Nb and Si under heating by a laser or an electron beam. From a thermodynamic perspective, high-melting-point Nb₅Si₃ particles are preferentially formed. Moreover, the particle size of the obtained Nb₅Si₃ particles is an order of magnitude smaller than that of the original Si powders in the in situ reaction. For example, as reported in a reference (Liu W, Xiong HP, Li N, et al. Microstructure characteristics and mechanical properties of Nb—17Si—23Ti ternary alloys fabricated by in situ reaction laser melting deposition [J]. Acta Metallurgica Sinica (English Letters), 2018, 31:362-370), when Nb and Si particles with an average particle size of about 80 μm were used for a laser in situ reaction, Nb—Si refractory particles at a micrometer scale were obtained, meaning that the size of Nb—Si compound particles generated by the laser in situ reaction is an order of magnitude smaller than the particle size of the powder raw material used. The present disclosure proposes using Si powders with a particle size of only 1 to 5 μm and Nb powders with a particle size of 10 to 20 μm as raw materials. Through scientific experiments and research, it has been demonstrated that under these conditions, a Nb₅Si₃/Nb(X, Y, Z . . . ) refractory high-entropy alloy reinforced with submicron Nb₅Si₃ particles can be obtained. Compared to a cast refractory alloy of the same composition, the size of the Nb₅Si₃ particle reinforcing phase can be significantly reduced from a level of tens of micrometers down to a submicron scale. In this way, on one hand, the brittleness of the particle-reinforced refractory alloy is greatly reduced, and on the other hand, based on the Orowan strengthening principle, the strength of the particle-reinforced refractory alloy will also be significantly improved.

It should be noted that if Nb₅Si₃ compound powders (typically with a particle size of tens of micrometers) are directly prepared for use, their melting point as well as manufacturing cost are high. Furthermore, in the subsequent laser additive manufacturing or electron beam selective melting deposition, where the Nb₅Si₃ compound powders are mixed with Nb(X, Y, Z . . . ) powders, only Nb₅Si₃ particles with a size of ten to several tens of micrometers are distributed in the obtained alloy. If smaller Nb₅Si₃ compound powders (e.g., below 10 μm) are directly prepared for use, the manufacturing cost is even higher, and the powders are suitable for neither separate-powder-fed additive manufacturing, nor mixed-powder-fed additive manufacturing with the Nb(X, Y, Z . . . ) refractory high-entropy alloy. Meanwhile, Nb₅Si₃ compound powders below 10 μm are obviously not within the ideal particle size range for laser/electron beam powder-bed additive manufacturing.

### Preparation of Spherical Nb-Based Refractory High-Entropy Alloy Powders

A Nb(X, Y, Z . . . ) refractory high-entropy alloy is designed to replace conventional solid solution matrices such as (Nb, Ti)ss, (Nb, Ti, Zr)ss, or (Nb, Ti, Mo)ss, and is prepared into spherical powders by a rotating electrode process.

In the present disclosure, the rotating electrode process is performed in an atomization chamber with an inert gas working pressure of preferably 0.115 to 0.135 MPa, and more preferably 0.120 to 0.130 MPa; a rotation speed of preferably 40,000 to 50,000 r/min, more preferably 42,000 to 48,000 r/min, and most preferably 45,000 to 46,000 r/min; an electric current of preferably 700 to 800 A, more preferably 750 to 760 A, and a feed rate of preferably 1.5 to 2 mm/s.

In the present disclosure, the atom percent of each element in the spherical Nb-based refractory high-entropy alloy powders is preferably 5% to 30%, and more preferably 10% to 25%, such as 5%, 10%, 15%, 20%, 25%, 30%, or in a range with any of the above values as an upper or lower limit.

### Preparation of a Nb-Based Refractory High-Entropy Alloy Reinforced with Submicron Nb₅Si₃ Particles

Using the aforementioned near-spherical Nb—Si composite powders and spherical Nb-based refractory high-entropy alloy powders as raw materials, a laser in situ reaction or an electron beam in situ reaction is performed to obtain a Nb-based refractory high-entropy alloy reinforced with submicron Nb₅Si₃ particles.

In the present disclosure, the mass ratio of the near-spherical Nb—Si composite powders to the spherical Nb-based refractory high-entropy alloy powders is preferably (25 to 30):(70 to 75), such as 25:75, 26:74, 27:73, 28:72, 29:71, 30:70, or in a range with any of the above values as an upper or lower limit.

In the present disclosure, a powder-fed laser additive manufacturing method, a laser selective melting method, or an electron beam selective melting method can be used to perform the in situ reaction between the near-spherical Nb—Si composite powders and the spherical Nb-based refractory high-entropy alloy powders.

The powder-fed laser additive manufacturing is performed with a laser power of preferably 700 to 1000 W, and more preferably 800 to 900 W; a scanning speed of preferably 600 mm/min; and a powder feed rate of 1000 r/min.

Specifically, if single-channel powder-fed laser additive manufacturing is used, the near-spherical Nb—Si composite powders and the spherical Nb-based refractory high-entropy alloy powders need to be first mixed for 1 to 5 h in a powder mixer to obtain the A+B mixed powders for subsequent additive manufacturing. However, if dual-channel powder-fed laser additive manufacturing is used, the near-spherical Nb—Si composite powders and the spherical Nb-based refractory high-entropy alloy powders are used separately, and no mixing step is required.

The laser selective melting preparation process is performed with a power of preferably 250 to 300 W; a scanning speed of preferably 900 to 1300 mm/s, and more preferably 1000 to 1200 mm/s; a scanning spacing of preferably 0.11 mm; and a layer thickness of preferably 50 μm.

The electron beam selective melting preparation process is performed with a vacuum level of preferably 2×10⁻³±0.5×10⁻⁴ mbar, and more preferably 2×10⁻³±0.3×10⁻⁴ mbar; a working voltage of preferably 60 kV; an electron beam power of preferably 5000 to 6000 W, and more preferably 4500 to 4600 W; a layer thickness of 50 μm; and a preheating temperature of preferably 300 °C to 700 °C, and more preferably 400 °C to 600 °C.

After the in situ reaction is completed, a homogenization heat treatment is preferably performed. During the homogenization heat treatment under a protective argon atmosphere, a small amount of Si dissolved in the Nb(X, Y, Z . . . ) high-entropy alloy matrix will precipitate and further react with Nb atoms in the refractory high-entropy alloy matrix to form finer, nanoscale Nb₅Si₃ particles. Under these conditions, a Nb₅Si₃/Nb(X, Y, Z . . . ) refractory high-entropy alloy material/component reinforced with further dispersed nano/submicron Nb₅Si₃ particles is obtained. In principle, the nano Nb₅Si₃ particles herein will provide a better strengthening effect than the submicron Nb₅Si₃ particles.

In the present disclosure, the homogenization heat treatment is performed at a temperature of preferably 1350 °C to 1450 °C, and more preferably 1400 °C, for 10 to 40 h, and more preferably 20 to 30 h.

The present disclosure provides a method for producing a Nb-based refractory high-entropy alloy reinforced with submicron Nb₅Si₃ particles by a laser in situ reaction or an electron beam in situ reaction, comprising: using near-spherical Nb—Si composite powders and spherical Nb-based refractory high-entropy alloy powders as raw materials, performing the laser in situ reaction or electron beam in situ reaction by selective melting, and obtaining the Nb-based refractory high-entropy alloy reinforced with submicron Nb₅Si₃ particles; the near-spherical Nb—Si composite powders are obtained by solid-state pressureless sintering of Nb powders with a particle size of 10 to 20 μm and Si powders with a particle size of 1 to 5 μm; and the Nb-based refractory high-entropy alloy is an alloy of Nb and at least one high-melting-point element selected from the group consisting of Ti, Zr, Hf, Nb, V, Ta, and Mo.

The present disclosure proposes using Si powders with a particle size of only 1 to 5 μm and Nb powders with a particle size of 10 to 20 μm as raw materials. Through scientific experiments and research, it has been demonstrated that under these conditions, a Nb₅Si₃/Nb(X, Y, Z . . . ) refractory high-entropy alloy reinforced with submicron Nb₅Si₃ particles can be obtained. Compared to a cast refractory alloy of the same composition, the size of the Nb₅Si₃ particle reinforcing phase can be significantly reduced from a level of tens of micrometers down to the submicron scale. In this way, on one hand, the brittleness of the particle-reinforced refractory alloy is greatly reduced, and on the other hand, based on the Orowan strengthening principle, the strength of the particle-reinforced refractory alloy will also be significantly improved.

Furthermore, the present disclosure designs a Nb(X, Y, Z . . . ) refractory high-entropy alloy as the alloy matrix. A super solid solution is formed within this multi-component refractory high-entropy alloy. Due to various strengthening and toughening mechanisms such as solid solution strengthening, lattice distortion strengthening, and precipitation strengthening, the Nb(X, Y, Z . . . ) refractory high-entropy alloy itself exhibits better strength and toughness as well as stable high-temperature strength compared to traditional binary alloys like Nb—Ti or ternary alloys like Nb—Ti—Zr or Nb—Ti—Mo. The Nb(X, Y, Z . . . ) refractory high-entropy alloy, reinforced with submicron Nb₅Si₃ particles obtained by in situ reaction additive manufacturing, is not only free of defects such as cracks during the additive manufacturing process, but the material or component so obtained by additive manufacturing can also be used directly in an as-manufactured state.

To further illustrate the present disclosure, the method for producing a Nb-based refractory high-entropy alloy reinforced with submicron Nb₅Si₃ particles by a laser in situ reaction or an electron beam in situ reaction provided by the present disclosure will be described in detail below in conjunction with examples, but these should not be construed as limiting the protection scope of the present disclosure.

### EXAMPLE 1: PREPARATION OF NB-SI COMPOSITE POWDER A

Si powders with a particle size of 1 to 5 μm and Nb powders with a particle size of 10 to 20 μm were mixed at an atomic ratio of 5:3. Then, a slurry was prepared: Nb powders, Si powders, PVA, and deionized water were weighed sequentially according to a mass ratio, placed into a ball milling jar, the ball milling jar was then fixed on a planetary ball mill, and the mixture was ball-milled to obtain a desired slurry. Then, a spray granulation process was performed to obtain Nb—Si elemental composite agglomerated powders with a controllable particle size range.

Subsequently, the above Nb—Si elemental composite agglomerated powders were processed in the following procedure to obtain near-spherical Nb—Si composite powder A. Solid-state pressureless sintering of the powders was performed under a high-purity argon protective atmosphere, wherein sintering densification and near-spheroidization were performed under conditions where neither of the two elemental powders melted, and the Nb—Si composite particles still remained in an elemental state. Typical parameters for the solid-state pressureless sintering were a sintering temperature of 800 °C and a sintering duration of 1 h. Then, a plasma spheroidization process was performed under a protective argon atmosphere, causing the surface layer of the Nb—Si composite agglomerated powders to be melted and achieving shaping and spheroidization of the powders. Typical parameters for the plasma spheroidization process were: an electric current of 700 A, a primary gas flow rate of 130 SCFH, an auxiliary gas flow rate of 10 SCFH, a carrier gas flow rate of 11 SCFH, and a powder feed rate of 2.0 r/min.

### EXAMPLE 2: PREPARATION OF NB(X, Y, Z . . . ) REFRACTORY HIGH-ENTROPY ALLOY POWDER B

A Nb(X, Y, Z . . . ) refractory high-entropy alloy was designed to replace conventional solid solution matrices such as (Nb, Ti)ss, (Nb, Ti, Zr)ss, or (Nb, Ti, Mo)ss. Each element in the Nb(X, Y, Z . . . ) refractory high-entropy alloy has an atom percent of 5% to 30%, and the spherical powder B was prepared from a cast alloy rod by a rotating electrode process. The rotating electrode process used high-purity argon as a working medium, and was performed with a working pressure of the inert gas in the atomization chamber was 0.115 MPa, the rotation speed was 40000 r/min, the electric current was 750 A, and the feed rate was 2 mm/s.

Powder A from Example 1 and powder B from Example 2 were proportioned at a mass ratio of 27:73, which was used as raw materials in the following Examples 3 to 6.

### EXAMPLE 3: SINGLE-CHANNEL POWDER-FED LASER ADDITIVE MANUFACTURING

(1) The refractory high-entropy alloy system was Nb35—Ti15—Zr20—Hf15—V15; a three-dimensional CAD model of a refractory alloy rectangular test block to be prepared, with dimensions of 15×15×10 mm³, was established, and a scanning path fill was performed for each sliced layer.

(2) Using the A+B mixed powders as raw materials, an in situ reaction between Nb and Si in a molten state and a rapid solidification process were carried out via a single-channel powder-fed laser additive manufacturing method to prepare a material or component of Nb₅Si₃/Nb(Ti, Zr, Hf, V) refractory high-entropy alloy reinforced with submicron Nb₅Si₃ particles. Typical parameters for the powder-fed laser additive manufacturing were a laser power of 800 W, a scanning speed of 600 mm/min, and a powder feed rate of 1000 r/min.

(3) The powder-fed laser additive manufacturing system started a forming process, in which powders were fed, melted, and solidified according to a computer-generated path, and were accumulated layer by layer until the preparation of the alloy sample or component was completed.

Technical effect obtained in this example: inspection and analysis by both SEM and TEM showed that in the microstructure of the obtained alloy sample or component, the Nb₅Si₃ particles had a submicron size of 200 to 600 nm and showed a dispersed distribution.

### EXAMPLE 4: DUAL-CHANNEL POWDER-FED LASER ADDITIVE MANUFACTURING

(1) The refractory high-entropy alloy system was Nb35—Ti15—Zr20—Hf15—V15; a three-dimensional CAD model of a refractory alloy rectangular test block to be prepared, with dimensions of 15×15×10 mm³, was established, and a scanning path fill was performed for each sliced layer.

(2) Using powder A and powder B, dual-channel powder-fed laser additive manufacturing was performed, wherein an in situ reaction between Nb and Si in a molten state and a rapid solidification process were carried out to prepare a material or component of Nb₅Si₃/Nb(Ti, Zr, Hf, V) refractory high-entropy alloy reinforced with submicron Nb₅Si₃ particles. Typical parameters for the powder-fed laser additive manufacturing were a laser power of 800 W, a scanning speed of 600 mm/min, and a powder feed rate of 1000 r/min.

(3) The powder-fed laser additive manufacturing system started a forming process, in which powders were fed, melted, and solidified according to a computer-generated path, and were accumulated layer by layer until the preparation of the alloy sample or component was completed.

Technical effect obtained in this example: inspection and analysis by both SEM and TEM showed that in the microstructure of the obtained alloy sample or component, the Nb₅Si₃ particles had a submicron size of 200 to 600 nm and showed a dispersed distribution.

### EXAMPLE 5: SELECTIVE LASER MELTING

(1) The refractory high-entropy alloy system was Nb30—Ti15—Zr15—Hf15—V15—Mo10; a 15×15×10 mm³ model was exported as an STL file, and Magics software used for model processing was used to perform model repair and placement of a component.

(2) A slice file was exported, and EP Hatch software was used to set process parameters for the component and accompanying samples: a power of 300 W, a scanning speed of 1200 mm/s, a scanning spacing of 0.11 mm, and a layer thickness of 50 μm.

(3) The A+B mixed powders were added to the material hopper of the equipment. After substrate preheating, leveling, and powder spreading, the chamber door was closed, argon was introduced with an inlet pressure of 0.5 MPa, and the ventilation cycle, the water cooling, the scanning galvanometer, and the laser were turned on. After the oxygen content reached below a set value of 1000 ppm, forming was started. Through a powder-bed laser additive manufacturing method, an in situ reaction between Nb and Si in a molten state and a rapid solidification process were carried out to prepare a material or component of Nb₅Si₃/Nb(Ti, Zr, Hf, V, Mo) refractory high-entropy alloy reinforced with submicron Nb₅Si₃ particles. After processing was completed, the material or component was taken out.

Technical effect obtained in this example: inspection and analysis by both SEM and TEM showed that in the microstructure of the obtained alloy sample or component, the Nb₅Si₃ particles had a submicron size of 300 to 700 nm and showed a dispersed distribution.

### EXAMPLE 6: SELECTIVE ELECTRON BEAM MELTING

(1) The refractory high-entropy alloy system was Nb25—Ti13—Zr12—Hf15—V15—Mo10—Ta10; a three-dimensional CAD model of a refractory alloy rectangular test block to be prepared, with dimensions of 15×15×70 mm³, was established, and was then subjected to layer slicing in the 70 mm height direction; a scanning path fill was performed for each sliced layer, and then slice information and scanning path information were imported into an electron beam selective melting system.

(2) First, a defocused electron beam was used to preheat the powder bed; the preheating temperature was adjustable at 600 °C, causing the alloy powders to slightly sinter.

(3) Then, each layer of powder was heated, melted, and solidified according to a computer-generated path, and was accumulated layer by layer until the preparation of the alloy sample was completed. The parameters for the electron beam selective melting were: a forming vacuum level maintained at 2×10⁻³±0.5×10⁻⁴ mbar, a working voltage of 60 kV, an electron beam power of 500 W, and a powder layer thickness for each layer of 50 μm. In this way, through a powder-bed electron beam additive manufacturing method, a material or component of Nb₅Si₃/Nb(Ti, Zr, Hf, V, Mo, Ta) refractory high-entropy alloy reinforced with submicron Nb₅Si₃ particles was prepared and obtained.

Technical effect obtained in this example: inspection and analysis by SEM showed that in the microstructure of the obtained alloy sample or component, the Nb₅Si₃ particles had a submicron size of 150 to 500 nm and showed a dispersed distribution.

Finally, the refractory high-entropy alloy materials/components prepared in Examples 3 to 6 were subjected to a homogenization heat treatment at 1400±50 °C for 10 to 40 h under a protective argon atmosphere. A small amount of Si dissolved in the Nb(X, Y, Z . . . ) high-entropy alloy matrix may precipitate and react with Nb atoms in the matrix alloy, and finer, nanoscale Nb₅Si₃ particles may be generated. In this way, a Nb₅Si₃/Nb(X, Y, Z . . . ) refractory high-entropy alloy material/component reinforced with dispersed nano/submicron Nb₅Si₃ particles was obtained. Here, the nano Nb₅Si₃ particles were able to provide a better strengthening effect than the submicron Nb₅Si₃ particles.

The above descriptions are only preferred embodiments of the present disclosure. It should be pointed out that for a person of ordinary skill in the art, several improvements and modifications can be made without departing from the principle of the present disclosure, and these improvements and modifications should also be considered within the protection scope of the present disclosure.

1. A method for producing an alloy by a laser in situ reaction or an electron beam in situ reaction, wherein the alloy is a Nb-based refractory high-entropy alloy reinforced with submicron Nb₅Si₃ particles and the method comprises:
using near-spherical Nb—Si composite powders and spherical Nb-based refractory high-entropy alloy powders as raw materials, performing the laser in situ reaction or electron beam in situ reaction by selective melting, and obtaining the Nb-based refractory high-entropy alloy reinforced with submicron Nb₅Si₃ particles;
wherein the near-spherical Nb—Si composite powders are obtained by solid-state pressureless sintering of Nb powders with a particle size of 10 to 20 μm and Si powders with a particle size of 1 to 5 μm; and
the Nb-based refractory high-entropy alloy is an alloy of Nb and at least one high-melting-point element selected from the group consisting of Ti, Zr, Hf, Nb, V, Ta and Mo.

2. The method according to claim 1, wherein the Nb powders and the Si powders have an atomic ratio of 4:3 to 6:3.

3. The method according to claim 1, wherein the solid-state pressureless sintering is performed at a temperature of 600 °C to 1000 °C for 0.5 to 2 h.

4. The method according to claim 1, wherein a plasma spheroidization is performed after the solid-state pressureless sintering; and the plasma spheroidization is performed with an electric current of 600 to 800 A, a primary gas flow rate of 110 to 130 SCFH, an auxiliary gas flow rate of 5 to 15 SCFH, a carrier gas flow rate of 10 to 15 SCFH, and a powder feed rate of 1.5 to 3 r/min.

5. The method according to claim 1, wherein the spherical Nb-based refractory high-entropy alloy powders are prepared from a cast Nb-based alloy rod by a rotating electrode process;
wherein the rotating electrode process is performed in an atomization chamber with an inert gas working pressure of 0.115 to 0.135 MPa, a rotation speed of 40000 to 50000 r/min, an electric current of 700 to 800 A, and a feed rate of 1.5 to 2 mm/s.

6. The method according to claim 5, wherein each element in the spherical Nb-based refractory high-entropy alloy powders has an atom percent of 5% to 30%.

7. The method according to claim 1, wherein the laser in situ reaction is performed by powder-fed laser additive manufacturing or by laser selective melting;
wherein the powder-fed laser additive manufacturing is performed with a laser power of 700 to 1000 W, a scanning speed of 600 mm/min, and a powder feed rate of 1000 r/min; and
the laser selective melting is performed with a power of 250 to 300 W, a scanning speed of 900 to 1300 mm/s, a scanning spacing of 0.11 mm, and a layer thickness of 50 μm.

8. The method according to claim 1, wherein the electron beam selective melting is performed with a vacuum level of 2×10⁻³±0.5×10⁻⁴ mbar, a working voltage of 60 kV, an electron beam power of 5000 to 6000 W, a layer thickness of 50 μm, and a preheating temperature of 300 °C to 700 °C.

9. The method according to claim 1, wherein the mass ratio of the near-spherical Nb—Si composite powders and the spherical Nb-based refractory high-entropy alloy powders is (25 to 30):(70 to 75).

10. The method according to claim 1, wherein a homogenization heat treatment is performed after the in situ reaction to obtain a Nb-based refractory high-entropy alloy reinforced with nano/submicron Nb₅Si₃ particles;
wherein the homogenization heat treatment is performed at a temperature of 1350 °C to 1450 °C for 10 to 40 h.
